(19) United States
(12) Patent Application Publication
(10) Pub. No.: US 2022/0128131 A1
(43) Pub. Date: Apr. 28, 2022

(54) Damper device for a wrap-around means of a wrap-around transmission

(71) Applicant: Schaeffler Technologies AG & Co. KG, Herzogenaurach (DE)

(72) Inventors: Nicolas Schehrer, Eschau (FR); Stephan Penner, Bühl (DE)

(73) Assignee: Schaeffler Technologies AG & Co. KG, Herzogenaurach (DE)

(21) Appl. No.: 17/295,891

(22) PCT Filed: Nov. 18, 2019
(86) PCT No.: PCT/DE2019/100986

§ 371 Date: May 21, 2021

(30) Foreign Application Priority Data
Dec. 4, 2018 (DE) 102018130768.3

(51) Int. Cl. F16H 7/18; F16H 9/18; F16H 9/24

(52) U.S. Cl. CPC F16H 7/18; F16H 2007/0872; F16H 9/24; F16H 9/18

(57) ABSTRACT

A damper device for a wrap-around means of a wrap-around transmission includes a carrier body formed from a composite reinforced plastic and comprising a surface, a sliding surface forming a first part of the surface, and a bearing surface for a pivoting means, the bearing surface forming a second part of the surface. The sliding surface or the bearing surface may be formed from a separate layer free of composite reinforcing means. The separate layer may be produced as a step of a multi component injection molding method with the carrier body being produced in a common injection mold in another step, as a coating on the carrier body, or as a separate component mechanically connected to the carrier body.

### CROSS-REFERENCE TO RELATED APPLICATIONS

This application is the United States National Phase of PCT Appln. No. PCT/DE2019/100986 filed Nov. 18, 2019, which claims priority to German Application No. DE102018130768.3 filed Dec. 4, 2018, the entire disclosures of which are incorporated by reference herein.

### TECHNICAL FIELD

The disclosure relates to a damper device for a wrap-around means of a wrap-around transmission, a wrap-around transmission having such a damper device, a drive train having such a wrap-around transmission, a motor vehicle having such a drive train, and an injection molding method and a manufacturing method for producing such a damper device.

### BACKGROUND

A wrap-around transmission, also referred to as a cone pulley wrap-around transmission or CVT (continuous variable transmission), for a drive train, for example of a motor vehicle, includes at least one first cone pulley pair arranged on a first shaft and a second cone pulley pair arranged on a second shaft, as well as a wrap-around means provided for torque transmission between the cone pulley pairs. A cone pulley pair includes two cone pulleys which are oriented with corresponding conical surfaces to each other and are axially movable relative to each other. The (first) cone pulley, also known as a loose pulley or movable pulley, can be displaced along the shaft axis thereof and the (second) cone pulley, also known as a fixed pulley, is fixed in the direction of the shaft axis. Such wrap-around transmissions have long been known, for example from DE 100 17 005 A1 or WO 2014/012 741 A1.

Due to the conical surfaces of the cone pulleys, the wrap-around means is shifted during operation of the wrap-around transmission in a radial direction between an inner position (small radius of action) and an outer position (large radius of action) by means of the relative axial movement of the cone pulleys of one of the cone pulley pairs. The wrap-around means thus runs on a variable radius of action, i.e., with a variable running radius. As a result, a different rotational speed transmission ratio and torque transmission ratio can be continuously adjusted from one cone pulley pair to the other cone pulley pair.

The wrap-around means forms two strands between the two cone pulley pairs, and, depending on the configuration and the direction of rotation of the cone pulley pairs, one of the strands forms a driving strand and the other strand forms a slack strand or a load strand and an empty strand.

The direction perpendicular to the (respective) strand and pointing from the inside to the outside or vice versa is called the transverse direction. The transverse direction of the first strand is therefore parallel to the transverse direction of the second strand only if the running radii on the two cone pulley pairs are the same. The direction perpendicular to the two strands and pointing from one cone pulley to the other cone pulley of a cone pulley pair is referred to as the axial direction. Thus, this is a direction parallel to the axes of rotation of the cone pulley pairs. The third spatial direction in the (ideal) plane of the (respective) strand is called the travel direction or the opposite travel direction or the longitudinal direction. The travel direction, transverse direction, and axial direction thus span a Cartesian coordinate system that moves along therewith (during operation). The aim is that the travel direction forms the ideally shortest connection between the adjacent running radii of the two conical pulley pairs, but in dynamic operation the alignment of the respective strand can deviate temporarily or permanently from this ideally shortest connection.

In such wrap-around transmissions, a damper apparatus is provided in the space between the cone pulley pairs. Such a damper apparatus can be arranged on the driving strand and/or on the slack strand of the wrap-around means and serves to guide and thus to limit vibrations of the wrap-around means. Such a damper apparatus is to be designed primarily with regard to an acoustically efficient traction means guide (wrap-around means guide). The length of the adjacent (sliding) surface for guiding the wrap-around means and the rigidity of the damper apparatus are decisive influencing factors. A damper apparatus is designed, for example, as a slide shoe or as a sliding guide with only one-sided, usually space-dependent (transverse to the wrap-around means) inside sliding surfaces, i.e., arranged between the two strands. Alternatively, the damper apparatus is designed as a slide rail having a sliding surface on both sides, i.e., both on the outside, i.e., outside of the wrap-around circle formed, and also on the inside sliding surface for the relevant strand of the wrap-around means formed. A sliding surface is also referred to as a contact surface or a guide surface. In the case of a slide rail, the two transversely opposite sliding surfaces are jointly referred to as a guide channel or sliding channel.

The damper apparatus is mounted by means of a pivoting means receptacle on a pivoting means having a pivot axis, which enables the damper apparatus to be pivoted about the pivot axis. In some applications, the damper apparatus can also be moved transversely, so that the damper apparatus follows a (steeper oval) curve, which deviates from a circular path around the pivot axis. The pivot axis thus forms the center of a (two-dimensional) polar coordinate system, wherein the (pure) pivot movement thus corresponds to the change in the polar angle and the transverse movement corresponding to the change in the polar radius. This translational movement, which is overlaid, i.e., superimposed, on the pivot movement, is disregarded below for the sake of clarity and is summarized under the term pivot movement. The pivot axis is oriented transversely to the travel direction of the wrap-around means, i.e., axially. This ensures that when the radii of action (running radii) of the wrap-around transmission are adjusted, the damper apparatus can be guided following the resulting new (tangential) alignment of the wrap-around means.

Damper devices are currently made of plastic, for example a low-friction polyamide. As a result of an operationally dependent temperature increase in the wrap-around transmission, the rigidity of the slide rail drops so much that the play increases in relation to the wrap-around transmission. This effect has a negative influence on the damping properties of the slide rail and thus increases the noise emissions of the wrap-around transmission.

### SUMMARY

The disclosure relates to a damper device for a wrap-around means of a wrap-around transmission, having at least the following components: a sliding surface; a bearing surface for a pivoting means; or a carrier body. The sliding surface and the bearing surface each form part of a surface of the carrier body. The carrier body is formed from a composite-reinforced plastic.

In the following, if the axial direction, transverse direction, or the travel direction and corresponding terms are used without explicitly indicating otherwise, reference is made to the mentioned spatial directions that move along therewith. Unless explicitly stated otherwise, ordinal numbers used in the previous and subsequent descriptions are used only for the purposes of clear distinction and do not indicate the order or ranking of the designated components. An ordinal number greater than one does not necessarily mean that another such component must be present.

According to the prior art, the damper device is set up for guiding or damping a wrap-around means or a strand of a wrap-around means of a wrap-around transmission. The wrap-around means and the wrap-around transmission are designed, for example, as is previously known. The wrap-around means is, for example, a link chain with rocker pressure pieces in a traction mechanism drive or a push link belt in a push link drive.

The damper device includes a sliding surface, which is designed to rest against the wrap-around means in a region shaped as a strand. Designed as a sliding guide, a single, for example transversely inner sliding surface, is provided. Designed as a slide rail, a pair of sliding surfaces are provided as a sliding channel to be transverse on both sides of the strand of the wrap-around means to be guided. So that the sliding surface can be tracked with the (target) alignment of the strand to be guided, a bearing surface is provided for a pivoting means receiving the damper device. The pivoting means is often designed as a stationary component, for example as a tube, and a relative movement takes place between the bearing surface and the pivoting means when the damper device follows the changed alignment of the strand. The pivoting means supports the damper device pivotably and, in one embodiment, additionally at least on one side, e.g. on both sides, axially. In one embodiment, the bearing surface is (additionally) set up for axial support on a further component, for example the gear housing of the wrap-around transmission.

A low frictional force is desired both on the bearing surface and on the sliding surface. Therefore, previously known damper devices are made of a low-friction material, for example a polyamide.

The carrier body is the main component of the damper device in terms of mass and volume expansion. This includes the task of holding the sliding surface and the bearing surface in the geometrically desired position and, associated therewith, the rigidification of the damper device. In one embodiment, the carrier body has further separate elements for this purpose, for example a rigidifying core, a rigidifying bracket, and ribs and webs. Such a carrier body may be formed in one piece by means of a single shaping method, e.g., without separate prefabricated inserts. This makes production simpler and cheaper.

For many applications the damper device may be designed in several parts, for example in two parts, for simple assembly into a wrap-around transmission. Two or more separate carrier bodies are then provided, which are mechanically connected to one another, for example in a form-fitting and/or force-fitting manner, for example interconnected as a 1-click rail. In an example embodiment, two carrier bodies are provided which are each structurally identical with regard to the sliding surface and the bearing surface, or are entirely identical.

The two carrier bodies may each have a portion, for example the same, of the respective sliding surface and/or the bearing surface. These regions are formed as part of a surface of the carrier body. Thus, these regions take up only a small part of the damper device in terms of both mass and volume expansion. For example, the surfaces are separated from the carrier body with a layer that is just thick enough that a desired surface property is reliably formed there.

In an example embodiment of the damper device, only the carrier body is formed from a composite-reinforced plastic.

The use of a composite-reinforced plastic as a material for the carrier body has a number of advantages. However, a composite-reinforced plastic brings a disadvantage. During a relative movement, a suitable composite-reinforcing means acts abrasively on a pivoting means and, for a wrap-around means, increases play over the service life. The pivoting movement and/or the damping effect of the damper device is thus impaired.

It must therefore be ensured that, over the service life, the wrap-around means and the pivoting means do not come into direct contact with the composite-reinforcing means, and are protected therefrom. For this purpose, the surfaces are formed as surfaces free from composite-reinforcing means or outer layers of the relevant part of the surface of the carrier body. This is achieved, for example, by the fact that the composite-reinforcing means is arranged in the final solidified state with a predetermined minimum distance from the surface.

In one embodiment, the composite-reinforcing means in the plastic forming the matrix of the carrier body has at least one of the following forms:

short fibers (shorter than about 1 mm [one millimeter]) or long fibers (longer than about 1 mm [one millimeter]), with long fibers in one embodiment being formed from continuous strip material, for example as rovings, and then in use having length of up to a multiple of the component expansion;

balls;

textile, non-soaked (not impregnated) or impregnated but not finally solidified, semi-finished products which are embedded in the matrix in a later step and finally solidified by means thereof or solidified (somewhat) simultaneously with this matrix;

mat and/or fleece, i.e., loop-forming or non-oriented fiber material;

woven fabrics, scrims and/or braids, that is, mesh-free (or oriented) fiber material; or knitted fabrics, also mesh-free (or oriented) fiber material.

The composite-reinforcing means is formed, for example, from at least one of the following materials:

carbon, for example as what is termed carbon fiber in a plastic matrix as CFRP [carbon fiber-reinforced plastic];

glass, for example as glass fiber in a plastic matrix as GFRP [glass fiber-reinforced plastic] and/or as glass ball(s); or

aramid, for example as an aramid fiber in a plastic matrix.

The composite-reinforcing means thus has no resilient shape or no shape and is only set up to absorb forces after it has been incorporated into the plastic of the carrier body forming the matrix.

Advantages of a carrier body made of a composite-reinforced plastics include:

an increase in rigidity;

a reduction in the temperature dependency of the channel height in a slide rail, i.e., the distance between the paired sliding surfaces of a slide rail;

a reduction in the time to bring an injection mold to series production, because the shrinkage due to the reduced volume of (matrix) plastic decreases and/or also at critical points by means of suitable positioning of the composite-reinforcing means a shrinkage due to capillary effects (for example fiber impregnation) in the composite-reinforcing means is decreased; and increased dimensional stability during series production.

It should be noted that the separate layers in one embodiment are each different from one another, for example the sliding surfaces and the bearing surface have different materials and/or surface properties. For a reduced production effort, all separate layers are connected to the carrier body with the same material and/or with the same type of connection. It is further proposed in an example embodiment of the damper device that the carrier body be made from a composite-reinforced plastic, and the sliding surface and/or the bearing surface are each formed from a separate layer.

According to this embodiment, only the carrier body is formed of a composite-reinforced plastic, while the sliding surface(s) and/or the bearing surface are formed from a separate layer. The relevant sliding surface and/or bearing surface have material properties and/or surface properties that differ from those of the carrier body. For example, the hardness of the separate layer is reduced compared to the carrier body, so that over the service life of the damper device and/or the wrap-around means the wear remains within a predetermined range, and no or only negligible wear occurs on the wrap-around means.

According to one embodiment, at least one of the separate layers is formed to be free from composite-reinforcing means. This ensures that no composite-reinforcing means protrudes from the surface of the sliding surface(s) and/or bearing surface in question, and so no composite-reinforcing means comes into direct contact with the strand to be guided. In addition, if the relevant separate layer is damaged, there is also no composite-reinforcing means exposed towards the strand. In this context, free from composite-reinforcing means means that the layer is free of fibers, spheres, and particles, at least such as composite-reinforcing means, which are harder than the plastic [matrix] in which they are embedded. This ensures that the hardness of the layer is not greater than that of the matrix-plastic used.

What is not meant here as composite-reinforcing means, however, are additives, for example (small) particles and/or embedded or integrated plastics. Additives generally change the overall properties of the plastic of the layer in question compared to a pure plastic, but not macroscopically selectively. Thus, the presence of additives in the surface and any damage thereto do not change the hardness or the abrasion effect on the strand to be guided. The additives are therefore selected in such a way that they are, at least almost, homogeneously embedded or integrated and are compatible with the desired abrasion properties. It should be pointed out at this point that there are surface properties with low friction and high hardness at the same time, as well as surface properties with low hardness and high friction.

It is also proposed in an example embodiment of the damper device that the respective separate layer is produced by means of one of the following methods:

as a step in a multi-component-injection molding method, where a carrier body is produced in a common injection mold in another step;

as a coating formed on the carrier body; or as a separate component which is mechanically connected to the carrier body.

For example, a multi-component injection molding method, for example a 2K injection molding method [two-component injection molding method] is advantageous for (at least) one separate layer applied at least in some regions because a damper device or one half of a damper device can be produced quickly and with only a single injection molding tool [die or injection mold]. Two extruders are provided in a 2K injection molding method, in which the thermoplastic material, for example, already provided with composite-reinforcing means, is injected at different times or at the same time into the injection mold. For example, the separate layer is injected at least in some regions and then the carrier body is injected with the composite-reinforcing means. Alternatively, the sequence is reversed or the injection of the different materials is carried out at overlapping times. In one embodiment, a further material is desired in another region, so that a corresponding number of further extruders are provided for this.

According to one embodiment, an injection channel or sprue channel is formed in the previously formed carrier body, through which the material for at least one of the separate layers is or has been introduced.

For some applications the entire carrier body may be provided with a coating. The prefabricated carrier body may be coated in an immersion bath, for example by electroplating, or sprayed.

In one embodiment, the carrier body and the separate layer may be prefabricated components which are connected to one another in a subsequent production step. For example, the layer is provided as a pulley material. That layer component is, for example, connected to the carrier body in a force-fitting manner, for example riveted, or materially connected to the carrier body, for example welded or glued. When riveting, the rivets may be arranged outside the sliding surface(s) and/or bearing surface, for example via a corner. In one embodiment, the layer component has connecting elements which can be connected to the carrier body in a form-fitting manner, for example clickably.

In one embodiment, a corresponding damper device is designed in several parts such that two or more carrier bodies are provided and one component is provided for at least one separate layer for each of the carrier bodies, for example, connecting them to one another. For example, a layer of the inner sliding surface is formed from a single separate component, which is connected to two carrier bodies or connects the two carrier bodies to one another.

It is further proposed in an example embodiment of the damper device that the separate layer is formed from a low-friction, e.g., self-lubricating material,

The separate layer has a low-friction design so that good damping, i.e., close contact with the strand to be guided, is possible simultaneously with a high degree of efficiency. In one embodiment, this is achieved by means of self-lubrication, for example by means of PTFE [polytetrafluoroethylene]. Alternatively or additionally, a slight roughness is formed, for example by means of a PA [polyamide], a polyamide also being implementable with a suitably low surface hardness.

According to one embodiment, the separate layer has a thickness corresponding to the wear and tear over a predetermined service life. For a desired service life, it can be determined using load models and tests or calculations how great a maximum abrasion will be over a service life with loading in accordance with operational requirements. The layer is then implemented with a corresponding thickness, e.g., a different thickness depending on the position, and a safety margin is also provided in one embodiment. In one embodiment of the carrier body, it can be assumed that the composite-reinforcing means does not directly adjoin the surface of the carrier body, so that a safety margin can be dispensed with because the carrier body can absorb such excessive abrasion with a high degree of probability or production technology to ensure that the composite-reinforcing means does not come into direct contact with the strand to be guided over the service life (or a service life extended by the safety margin).

It is also proposed in an example embodiment of the damper device that the composite-reinforced plastic contains at least one of the following composite-reinforcing means:

short-fiber material, e.g., with a composite-reinforced granular material made of a thermoplastic material for an injection molding method;

long fiber-material, e.g., with a composite-reinforced prepreg made of a thermosetting plastic for a thermal molding process; or

ball material.

Short-fiber material has the advantage that it does not influence a conventional manufacturing process so significantly that it must be changed. For example, short-fiber material can be incorporated into an injection molding method, with a thermoplastic granular material being provided with short-fiber material, for example.

Long-fiber material has the advantage that large rigidifying effects can be achieved. This is helpful in the case of well-known unidirectional and/or bidirectional load cases when the long fibers are aligned according to the load case so that they are then subjected to tensile stress. Long-fiber material is easy to process industrially as a prepreg. The prepreg is not only fiber mats impregnated with a thermoset, for example an epoxy resin, but also preforms, for example BMCs [bulk molding compounds], which are given the final shape thereof and cross-linked in a thermal process. However, organic sheets in which short fibers are generally bound in a thermoplastic matrix are also suitable as a prepreg.

Additionally or alternatively, spherical material is suitable, so that the mass of the carrier body can be reduced with the same or only negligibly reduced rigidity.

It is also proposed in an example embodiment of the damper device that in a predetermined region of the carrier body with a small number of main load directions, e.g., with a unidirectional and/or bidirectional main load direction, a long fiber and/or a mesh-free fiber mat corresponding to the main load direction is aligned for use.

In one embodiment, the long fiber or the mesh-free (or oriented) fiber mat is inserted in a coordinated manner, that is to say aligned as a function of the load, before the plastic is injected or poured into the injection mold. Then the plastic is injected. The long fiber or the fiber mat may not yet be impregnated, for example loosely inserted into the injection mold or glued in places.

Alternatively, the long fiber or the mesh-free (or oriented) fiber mat is only applied subsequently after a semi-finished product carrier body is formed, e.g., after the separate layer is applied on the semi-finished product carrier body.

In a further embodiment, the regions are inserted as a prefabricated semi-finished product in an injection mold and are then encapsulated in a thermoplastic material or encapsulated in a thermosetting plastic to form the carrier body.

According to a further aspect, an injection molding method for producing a damper device according to an embodiment according to the above description is proposed, the injection molding method including at least the following steps:

a. providing an injection mold;

b. inserting long fibers and/or mesh-free fiber mats into the injection mold in the predetermined regions;

c. injecting a plastic; and

d. demolding the completed damper device.

The method proposed here is carried out, for example, according to an embodiment according to the preceding description, so that reference is made to the corresponding description. For a large number of pieces and/or for manufacturing accuracy, the injection mold is formed from a metal, for example steel or aluminum. The injection mold may be designed without inclusions, i.e., without a lost mold. The injection mold is for holding long fibers and/or mesh-free (or oriented) fiber mats inserted in step b., for example by means of a form-fitting insertion region, magnets, or adhesive points, by means of which the insertion material is held securely in position.

A single injection mold can be used for a damper device with two carrier bodies, so for a damper device are formed two identical carrier bodies, which during use are connected to one another, e.g., in a form-fitting manner.

The injection mold may be designed in such a way that the carrier body can be easily removed at least after cooling, e.g., still hot. In one embodiment, the injection mold is designed to be forcibly cooled.

It is further proposed in an example embodiment of the injection molding method that the injection in step c., is a multi-component-injection molding method in which the sliding surface and/or the bearing surface is injected with a granular material free from composite-reinforcing means and the carrier body is injected with a composite-reinforced granular material.

In this embodiment, the injection mold in step d., the finished damper device or a finished half of the damper device can be removed.

According to a further aspect, a production method for producing a damper device according to an embodiment according to the above description is proposed, wherein a carrier body is produced and the production method then comprises at least one of the following steps:

i. applying one of the separate layers; and

ii. in predetermined regions, applying long fibers and/or mesh-free fiber mats, which are aligned according to the main load directions.

The method proposed here is also carried out, for example, according to an embodiment according to the preceding description, so that reference is made to the corresponding description.

In this manufacturing process, the separate layer, the long fibers and/or the mesh-free (or oriented) fiber mats are only applied after the carrier body has been completed. In one embodiment, the separate layers are first applied, for example in a multi-component injection molding method, for example as described above, with, for example, no long fibers and no fiber mats being introduced into the injection mold. The long fibers and/or the mesh-free (or oriented) fiber mats are then applied in predetermined regions as described above.

In an alternative embodiment, the carrier body is formed from a preform, for example a BMC. The separate layer, the long fibers and/or the mesh-free (or oriented) fiber mats are then applied.

It is further proposed in an example embodiment of the manufacturing method that the separate layer to be applied is formed by means of dip coating in step i.

In this embodiment, the separate layer is applied as a dip coating. The long fibers and/or mesh-free fiber mats may be already applied to the carrier body in the predetermined regions, and connected to the carrier body in a solid manner, for example.

According to a further aspect, a wrap-around transmission is proposed for a drive train, having the following components:

a transmission input shaft having a first cone pulley pair;

a transmission output shaft having a second cone pulley pair;

a wrap-around means by means of which the first cone pulley pair is connected to the second cone pulley pair in a torque-transmitting manner; and

a damper device according to an embodiment according to the above description. The damper device rests against a wrap-around means for dampening the wrap-around means with the sliding surface.

With the wrap-around transmission proposed here, a torque can be transmitted from a transmission input shaft to a transmission output shaft, and vice versa, in a step-up or step-down manner, wherein the transmission can be continuously adjusted, at least in some regions. A wrap-around transmission is designed, for example, as shown at the outset, and the damper apparatus fulfills the task explained at the outset.

The components of the wrap-around transmission are usually enclosed and/or supported by a transmission housing. For example, the pivot bearing for the pivoting means receptacle is mounted as a bearing tube to the transmission housing and/or is movably supported thereon. The input shaft and the output shaft extend from outside into the transmission housing and may be supported on the transmission housing by means of bearings. The cone pulley pairs are housed by means of the gear housing, and the gear housing may form the abutment for the axial actuation of the movable cone pulleys.

Furthermore, the gear housing may form connections for attaching the wrap-around transmission and, for example, for the supply of hydraulic fluid. For this purpose, the transmission housing has a number of boundary conditions and must fit into a given installation space. This interaction results in an inner wall that limits the shape and movement of the components. This represents the decisive limitation for the pivotable damper apparatus, for example, so that the shape is constructed on the basis of the gear housing or the inner wall thereof to achieve the best possible damping property.

The wrap-around transmission proposed here has one or two damper apparatuses, of which at least one damper apparatus according to the above description has a high rigidity with at the same time low wear effect on the wrap-around means and/or the pivoting means. This is achieved by means of the at least one separate layer on at least one of the sliding surfaces or the bearing surface.

According to a further aspect, a drive train is proposed, having at least one drive unit having a respective drive shaft, at least one consumer and a wrap-around transmission according to an embodiment as described above. The drive shaft can be connected for torque transmission with the at least one consumer with changeable transmission ratio by means of the wrap-around transmission.

The drive train is designed to transmit a torque provided by a drive unit, for example an internal combustion engine and/or an electric machine, and output via the drive shaft thereof, i.e., the combustion shaft and/or the (electric) rotor shaft, for example, for use as required, i.e., taking into account the required speed and the required torque. One use is, for example, an electrical generator to provide electrical energy or the transmission of torque to a drive wheel of a motor vehicle to propel same.

To transmit the torque in a targeted manner and/or by means of a manual transmission with different transmission ratios, the use of the wrap-around transmission described above permits a large transmission ratio spread in a small space and operation of the drive unit within a small optimal speed range. Conversely, a receiving of an inertia energy introduced by, for example, a drive wheel, which then forms a drive unit in the above definition, can be implemented by means of the wrap-around transmission on an electric generator for recuperation (the electrical storage of braking energy) with a correspondingly configured torque transmission line.

Furthermore, in an example embodiment, a plurality of drive units is provided, which can be operated in series or in parallel, or can be operated in a decoupled manner from each other and the torque of which can be made available as required by means of a wrap-around transmission according to the above description. One exemplary application is a hybrid drive train including an electric machine and an internal combustion engine.

The wrap-around transmission proposed here enables the use of a damper apparatus that efficiently utilizes the available installation space, so that good damping properties can be achieved due to an increase in the rigidity of the inner sliding surface. The noise emissions of such a drive train are thus reduced. The efficiency can also be increased as a result of a reduction in the vibrations. At the same time, by means of the at least one separate layer, slight wear can be achieved on the wrap-around means and/or the pivoting means, and the service life of the wrap-around transmission can thus be extended.

According to a further aspect, a motor vehicle is proposed, including at least one drive wheel which can be driven by means of a drive train according to an embodiment as described above.

Most motor vehicles today have a front-wheel drive and sometimes arrange the drive unit, for example an internal combustion engine and/or an electric machine, in front of the driver's cab and transversely to the main direction of travel. The radial installation space is small in such an arrangement, and it is therefore advantageous to use a small-sized wrap-around transmission. The use of a wrap-around transmission in motorized two-wheeled vehicles is similar, for which an ever-increasing performance is required compared with the previously known two-wheeled vehicles with the same installation space. With the hybridization of the drive trains, this problem is also exacerbated for rear axle arrangements, and also here both in the longitudinal arrangement and in the transverse arrangement of the drive machines.

In the motor vehicle proposed here with the drive train described above, low noise emission is achieved, which means that less effort is required with regard to sound insulation. This means that less space is required for the wrap-around transmission. It is also possible, alternatively or additionally, to establish low noise emissions and a long service life.

### BRIEF DESCRIPTION OF THE DRAWINGS

The disclosure described above is explained in detail below based on the relevant technical background with reference to the associated drawings, which show example embodiments. The disclosure is in no way restricted by the purely schematic drawings, while it should be noted that the drawings are not dimensionally accurate and are not suitable for defining proportions. In the figures,

FIG. 1 shows a perspective view of one half of a damper apparatus;

FIG. 2 shows a perspective view of a carrier body;

FIG. 3 shows a perspective view of one half of a damper apparatus with a coating;

FIG. 4 shows a wrap-around transmission with a strand guided by a slide rail; and

FIG. 5 shows a drive train in a motor vehicle with a wrap-around transmission.

### DETAILED DESCRIPTION

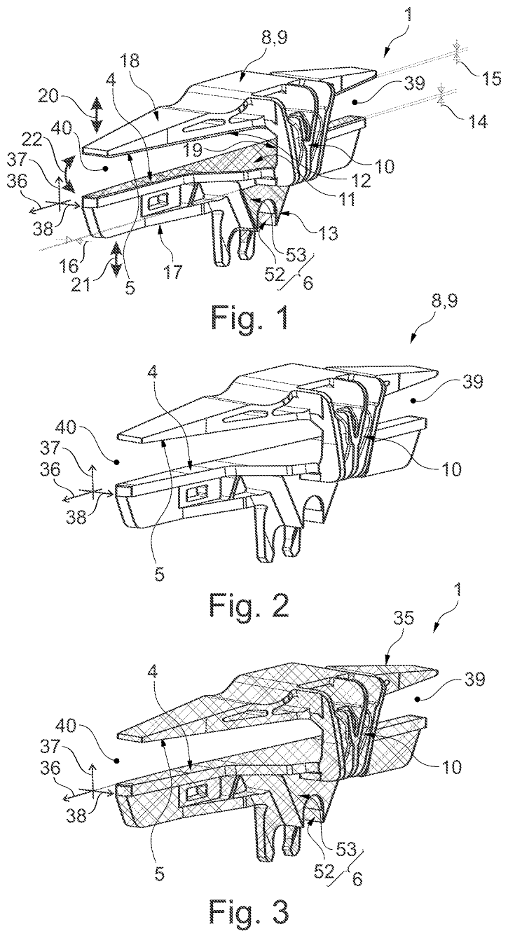

In FIG. 1, (one half of) a damper apparatus 1 is shown in a perspective view. The second half may be formed to be identical to that shown. Correspondingly, in terms of volume, the main portion is formed by the first carrier body 8 (the first half) or the second carrier body 9 (the second half). The damper apparatus 1 shown is designed here as a slide rail with an inner sliding surface 4 and an outer sliding surface 5. A Cartesian coordinate system (moved along therewith) is shown in the travel direction 36 behind the damper apparatus 1, that is to say at the outlet side 40. The transverse direction 37 is perpendicular and the axial direction 38 is oriented transversely in the illustration. The inlet side 39 is shown opposite in the travel direction.

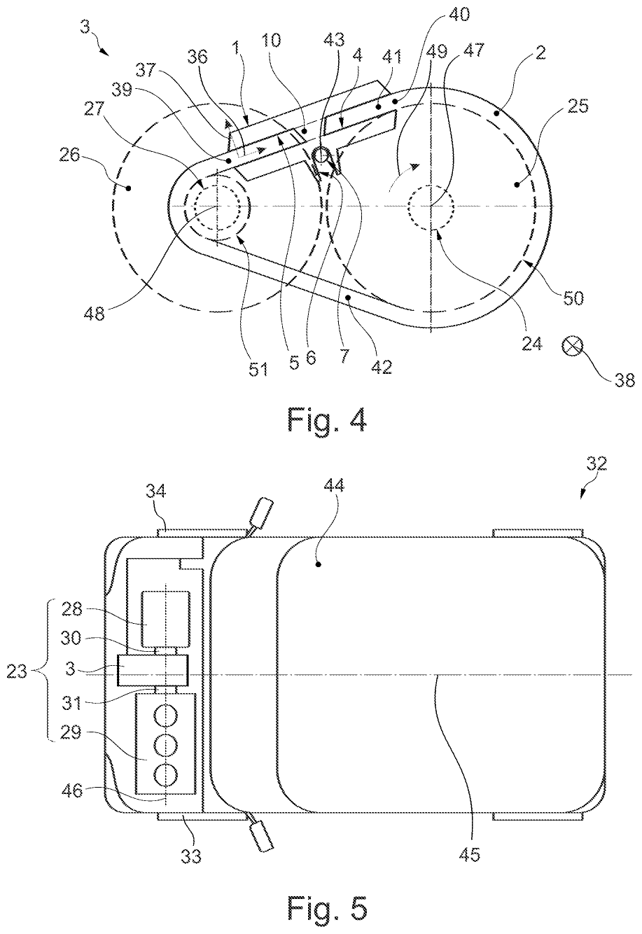

At the bottom of the illustration, i.e., transversely inside, can be seen (one half of) a pivoting means receptacle having the bearing surface 6, the function of which becomes clear in connection with FIG. 4. The bearing surface 6 is divided into a pivoting partial bearing surface 52 radial to a pivoting means 7 (see FIG. 4) and an axial partial bearing surface 53 axial to an axial bearing surface, for example an axial flange of a pivoting means 7.

The two sliding surfaces 4 and 5 are each composed of a proportion of both halves of the damper device 1. The two sliding surfaces 4 and 5 are kept mechanically transversely spaced from one another by means of the transverse web 10. The inner sliding surface 4 is formed by a first separate layer 11 and the outer sliding surface 5 is formed by a second separate layer 12. The bearing surface 6 is formed by a third separate layer 13.

The first separate layer 11 is designed with a first thickness 14 in the middle part thereof, i.e., outside an inlet and an outlet, and the second separate layer 12 is likewise designed with a second thickness 15 in the middle part thereof, i.e., outside an inlet and an outlet. Furthermore, the bearing surface 6 is designed with a third thickness 16 at least in the region of the main load, which is displayed pars pro toto on the axial partial bearing surface 53.

Regardless thereof, for example also provided in the embodiment according to FIG. 2 and FIG. 3, in the first region at the outlet side 40 on the rear side, i.e., transversely inside, the inner sliding surface 4 is a predetermined first region 17 and on the rear side, i.e., transversely outside, the outer one sliding surface 5 is a predetermined second region 18 having a long-fiber reinforcement, for example rovings or a knitted fabric, reinforced against a first main load direction 20 or a second main load direction 21, which corresponds to a bending movement about the axial direction 38 and/or about the travel direction 36. In one embodiment, a corresponding reinforcement is provided in predetermined regions in addition to or alone on the inlet side 39. Furthermore, alternatively or additionally, a predetermined third region 19 is provided with the same or a different type of long-fiber reinforcement against a bending movement around the travel direction 36, i.e., a third main load direction 22 shown here as a torque, i.e., on the inside of the transverse web 10.

In FIG. 2, a carrier body 8 or 9 is shown in a similar embodiment to that shown in FIG. 1, the carrier body 8 or 9 not yet having any sliding surfaces and no bearing surface and no separate layers. For elucidation, reference is made to the preceding description. The carrier body 8, 9 shown is formed, for example, in one step without insert components, for example from a BMC-prepreg.

In FIG. 3 the (half of the) damper device 1 is now shown in the final state, a (here completely enclosing) coating 35 is now applied. This coating forms the sliding surfaces 4 and 5 and the bearing surface 6.

FIG. 4 schematically shows a damper apparatus 1 in a wrap-around transmission 3, and a first strand 41 of a wrap-around means 2 is guided by means of the damper apparatus 1 and is thus dampened. The wrap-around means 2 connects an input-side cone pulley pair 25 to an output-side cone pulley pair 26 in a torque-transmitting manner. An input-side radius of action 50, on which the wrap-around means 2 runs, is in contact with the input-side cone pulley pair 25 through a corresponding spacing apart in the axial direction 38 (corresponding to the alignment of the axes of rotation 47 and 48), which here for example is rotatably connected in a torque-transmitting manner with a transmission input shaft 24 around an input-side axis of rotation 47. An output-side radius of action 51, on which the wrap-around means 2 runs, is in contact with the output-side cone pulley pair 26 through a corresponding spacing apart in the axial direction 38, which here for example is rotatably connected in a torque-transmitting manner with a transmission output shaft 27 around an output-side axis of rotation 48. The (changeable) ratio of the two radii of action 50, 51 results in the transmission ratio between the transmission input shaft 24 and the transmission output shaft 27.

Between the two cone pulley pairs 25 and 26, the first strand 41 (shown here) and the second strand 42 are shown in an ideal tangential alignment, so that the parallel alignment of the travel direction 36 is established. The transverse direction 37 shown here is defined as the third spatial axis perpendicular to the travel direction 36 and perpendicular to the axial direction 38. This is understood as a (radius of action-dependent) coordinate system moving along therewith. Therefore, both the travel direction 36 shown and the transverse direction 37 apply only to the damper apparatus 1 shown (here designed as a slide rail) and the first strand 41, and only in the case of the established input-side radius of action 50 and corresponding output-side radius of action 51 shown.

The damper apparatus 1 designed as a slide rail rests with the inner sliding surface 4 thereof and the outer sliding surface 5 thereof connected thereto by means of the (right) transverse web 10 on the first strand 41 of the wrap-around means 2. So that the sliding surfaces 4, 5 can follow the variable tangential alignment, i.e., the travel direction 36, when the radii of action 50, 51 change, the bearing surface 6 is mounted on a pivoting means 7 with a pivot axis 43, for example a conventional holding tube. As a result, the damper apparatus 1 is mounted pivotably about the pivot axis 43. In the exemplary embodiment shown, the pivoting movement is composed of a superposition of a pure angular movement and a transverse movement, so that in deviation from a movement along a circular path, a movement along an oval (steeper) curved path occurs.

In the circumferential direction 49 shown by way of example, and when the torque is input via the transmission input shaft 24, the damper apparatus 1 in the illustration forms the inlet side 39 on the left and the outlet side 40 on the right. When running as a traction mechanism drive, the first strand 41 then forms the load strand as the driving strand and the second strand 42 forms the empty strand. If the wrap-around means 2 is designed as a push link belt, under otherwise identical conditions, either the first strand 41 is guided as an empty strand by means of the damper apparatus 1, or the first strand 41 is designed as a load strand and a slack strand and the circumferential direction 49 and the travel direction 36 are reversed when torque is input via the input-side cone pulley pair 25. Alternatively, when the transmission output shaft 27 and the transmission input shaft 24 are interchanged, the output-side cone pulley pair 26 forms the torque input.

FIG. 5 shows a drive train 23 arranged in a motor vehicle 32 with the motor axis 46 thereof (optionally) transverse to the longitudinal axis 45 (optionally) in front of the driver's cab 44. Here, the wrap-around transmission 3 is connected on the input side with the electric output shaft 30 of the electric drive unit 28 and with the combustion engine output shaft 31 of the electric drive unit 29. From these drive units 28, 29 or via the drive shafts 30, 31 thereof, a torque for the drive train 23 is delivered simultaneously or at different times. However, a torque can also be absorbed by at least one of the drive units 28, 29, for example by means of the internal combustion engine for engine braking and/or by means of the electric drive machine for recuperation of braking energy. On the output side, the wrap-around transmission 3 is connected to a purely schematically illustrated output, so that here a left drive wheel 33 and a right drive wheel 34 (consumer) are supplied with torque by the drive units 28, 29 with a variable transmission ratio.

With the slide rail proposed here, inexpensive production can be achieved at the same time having high rigidity and a long service life.

### REFERENCE NUMERALS

1 Damper device
2 Wrap-around means
3 Wrap-around transmission
4 Inner sliding surface
5 Outer sliding surface
6 Bearing surface
7 Pivoting means
8 First carrier body
9 Second carrier body
10 Transverse web
11 First layer
12 Second layer
13 Third layer
14 First thickness
15 Second thickness
16 Third thickness
17 First region
18 Second region
19 Third region
20 First main load direction
21 Second main load direction
22 Third main load direction
23 Hybrid drive train
24 Transmission input shaft
25 Input-side cone pulley pair
26 Output-side cone pulley pair
27 Transmission output shaft
28 Electric drive unit
29 Internal combustion drive unit
30 Electric output shaft
31 Internal combustion output shaft
32 Hybrid motor vehicle
33 Left drive wheel
34 Right drive wheel
35 Coating
36 Travel direction
37 Transverse direction
38 Axial direction
39 Inlet side
40 Outlet side
41 First strand
42 Second strand
43 Pivot axis
44 Driver's cab
45 Longitudinal axis
46 Motor axis
47 Input-side axis of rotation
48 Output-side axis of rotation
49 Circumferential direction
50 Input-side radius of action
51 Output-side radius of action
52 Pivoting partial bearing surface
53 Axial partial bearing surface

1.-10. (canceled)

11. A damper device for a wrap-around means of a wrap-around transmission, comprising:
a carrier body formed from a composite reinforced plastic and comprising a surface;
a sliding surface forming a first part of the surface; and
a bearing surface for a pivoting means, the bearing surface forming a second part of the surface.

12. The damper device of claim 11 wherein:
the sliding surface is formed from a separate layer free of composite reinforcing means; or
the bearing surface is formed from a separate layer free of composite reinforcing means.

13. The damper device of claim 12 wherein the separate layer is produced:
as a step of a multi component injection molding method, the carrier body being produced in a common injection mold in another step;
as a coating on the carrier body; or
as a separate component mechanically connected to the carrier body.

14. The damper device of claim 12 wherein the separate layer is formed from a low-friction material.

15. The damper device of claim 12 wherein the separate layer is formed from a preferably self-lubricating material.

16. The damper device of claim 12 wherein the separate layer has a thickness greater than a calculated abrasive wear during a predetermined service life of the damper device.

17. The damper device of claim 11 wherein the composite reinforced plastic comprises a short-fiber material, a long-fiber material, or a ball material.

18. The damper device of claim 17 wherein the composite reinforced plastic comprises the short-fiber material with a composite reinforced granular material made of a thermoplastic material for an injection molding process.

19. The damper device of claim 17 wherein the composite reinforced plastic comprises the long-fiber material with a composite reinforced prepreg made of a thermosetting plastic for a thermal molding process.

20. The damper device of claim 11 wherein, in a predetermined region of the carrier body comprising a small number of main load directions, the composite reinforced plastic comprises a long fiber or a mesh-free fiber mat aligned with the small number of main load directions.

21. The damper device of claim 20 wherein the predetermined region comprises a unidirectional or a bidirectional main load direction.

22. An method for producing the damper device of claim 20, comprising:
providing an injection mold;
inserting the long fiber or the mesh-free fiber mat into the injection mold in the predetermined region;
injecting a plastic; and
demolding the damper device.

23. The method of claim 22 wherein injecting the plastic comprises a multi component injection molding method wherein:
the sliding surface or the bearing surface is injected from a granular material free of composite reinforcing means; and
the carrier body is injected from a composite reinforced granular material.

24. A method for manufacturing the damper device of claim 12, comprising:
forming the carrier body with long fibers or mesh-free fiber mats in predetermined regions aligned with a main load direction; and
applying the separate layer.

25. The method of claim 24 wherein the separate layer is applied by dip coating.
